(19) United States
(12) Patent Application Publication
(10) Pub. No.: US 2026/0251309 A1
(43) Pub. Date: Aug. 27, 2026

(54) COVER FOR SWITCH MECHANISM FOR COOKTOP

(71) Applicant: WHIRLPOOL CORPORATION, Benton Harbor, MI (US)

(72) Inventors: James Brown, Charleston, TN (US); Krzysztof Wozniak, Benton Harbor, MI (US)

(21) Appl. No.: 19/065,053

(22) Filed: Feb. 27, 2025

(51) Int. Cl. F24C 3/12; H01H 3/02; H01H 3/08; H01H 9/02

(52) U.S. Cl. CPC F24C 3/126; H01H 3/0206; H01H 3/08; H01H 9/02

(57) ABSTRACT

A switch assembly for a cooktop may include a base portion having a base body forming a cavity and defining at least one wire hole at each of opposite ends of the base portion, the base portion configured to receive at least one wire therein, wherein the at least one wire extends out of a respective wire hole of the wire holes at the opposite ends of the base body, and a cover attachable to the base portion and configured to close the cavity to maintain the at least one wire within the cavity.

### TECHNICAL FIELD

Described herein are spark switch mechanisms with covers for cooktops.

### BACKGROUND

A cooking appliance is used to cook meals and other foodstuffs on a cooktop or within an oven. Gas cooking appliances typically include spark switches and electronics to ignite the burners of the cooking appliance. These spark switches may undergo certain testing and have certain requirements, such as sponge tests or other liquid resistance tests.

### SUMMARY

A switch assembly for a cooktop may include a base portion having a base body forming a cavity and defining at least one wire hole at each of opposite ends of the base portion, the base portion configured to receive at least one wire therein, wherein the at least one wire extends out of a respective wire hole of the wire holes at the opposite ends of the base body, and a cover attachable to the base portion and configured to close the cavity to maintain the at least one wire within the cavity, wherein, the cover has a length longer than that of base portion such that the cover includes an overhang corresponding to each opposite end extending beyond the opposite ends of the base body to cover at least a portion of the at least one wire extending from the wire holes of the base body, the overhang further limiting the at least one wire from extending upward and away from the base portion to limit exposure to the wire holes and inhibiting exposure to liquid at the wire holes.

In one example, each overhang forms a lip extending towards the base portion at each of two distal and opposite ends of the cover to further guide the at least one wire towards the base portion to limit exposure to the wire holes.

In another example, each of the lips extend across the respective distal end of the cover.

In one example, each of the at least one wire holes includes a pair of wire holes defined at each of the opposite ends of the base portion.

In another example, the base portion defines an open top configured to receive the at least one wire in the cavity during assembly and the wire holes being open to the open top.

In one embodiment, the cover includes at least one attachment mechanism configured to engage and connect with the base portion during assembly.

In another embodiment, the attachment mechanism includes at least one projection configured to engage with a slot defined in the base portion.

A switch assembly for a cooktop may include a quadratic base portion having a base body forming a cavity and defining wire holes at each of opposite sides of the base portion, the base portion configured to receive at least one wire therein, wherein the at least one wire extends out a respective wire hole of the wire holes at the opposite sides of the base body, a quadratic cover attachable to the base portion and configured to close the cavity to maintain the at least one wire within the cavity, and wherein the cover has a length longer than that of base portion such that the cover includes an overhang at each opposite end extending beyond the opposite sides of the base body to cover at least a portion of the at least one wire extending from the wire holes of the base body, the overhang further limiting the at least one wire from extending upward and away from the base portion to limit exposure to the wire holes and inhibiting exposure to liquid at the wire holes.

In one embodiment, each overhang includes a lip extending towards the base portion at each of two distal and opposite sides of the cover to further guide the at least one wire towards the base portion to limit exposure to the wire holes.

In another embodiment, each of the lips extend across the respective distal end of the cover.

In one example, each of the at least one wire holes includes a pair of wire holes defined at each of the opposite sides of the base portion.

In another example, the base portion defines an open top configured to receive the at least one wire in the cavity during assembly and the wire holes being open to the open top.

In one embodiment, the cover includes at least one attachment mechanism configured to engage and connect with the base portion during assembly.

In another embodiment, the attachment mechanism includes at least one projection configured to engage with a slot defined by the base portion.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a top view of an example cooktop, such as a gas cooktop.

FIG. 2 illustrates side view of an example switch assembly arranged at or near each of the knobs and burners of the cooktop and having at least one wire extending therefrom.

FIG. 3 illustrates a perspective side view of the example switch assembly of FIG. 2.

FIG. 4 illustrates a cut-away perspective view, taken along A-A’ of the example switch assembly of FIG. 3.

FIG. 5 illustrates a perspective bottom view of the switch assembly of FIG. 2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Knobs, switches, actuators, etc., of gas cooktops and freestanding ranges often include various harnesses and wires. These wires are often extended through and out of the openings in the switch, which may be exposed to liquid. This may be the case during testing of the cooktop where liquid enters near the gas valve shaft and impacts a switch of a switch harness that is mounted on the gas valve. Such tests may include liquid resistance tests to verify the sealing integrity of electrical components. These tests help ensure that appliances may withstand exposure to such liquids without failure.

In order to comply with certain requirements, mechanisms are put in place to ensure the integrity of electronic components. Typically, what is known as an ‘umbrella’ is used to prevent liquid from entering the switch. However, with conventional umbrellas, drops of liquid may still enter the switch at the wire holes. Other conventional solutions may include a more robust switch with a cover and bottom portion clutching the wires. However, this solution requires a larger footprint and more materials.

Disclosed herein is a switch assembly having a cover that extends beyond a base and a structure that pushes the wires conically downward and away from the center shaft to force any liquid down and away from the wires and to route liquid away from the wire holes. The cover may extend horizontally over the base to create an overhang over the base. In the case where the switch assembly is cubical, the cover may extend horizontally over two opposite sides, creating a “T-like” cross-section. In addition to the cover, the switch assembly may include a block or seal at the wire openings to further reduce the amount of liquid that may enter the area of the openings.

With this structure in place, the need for a larger cover can be avoided, while maintaining the ability to pass a regulatory sponge test. Further, a more water-safe cooking appliance is appreciated while avoiding the subjectivity of manual routing required by some installation processes.

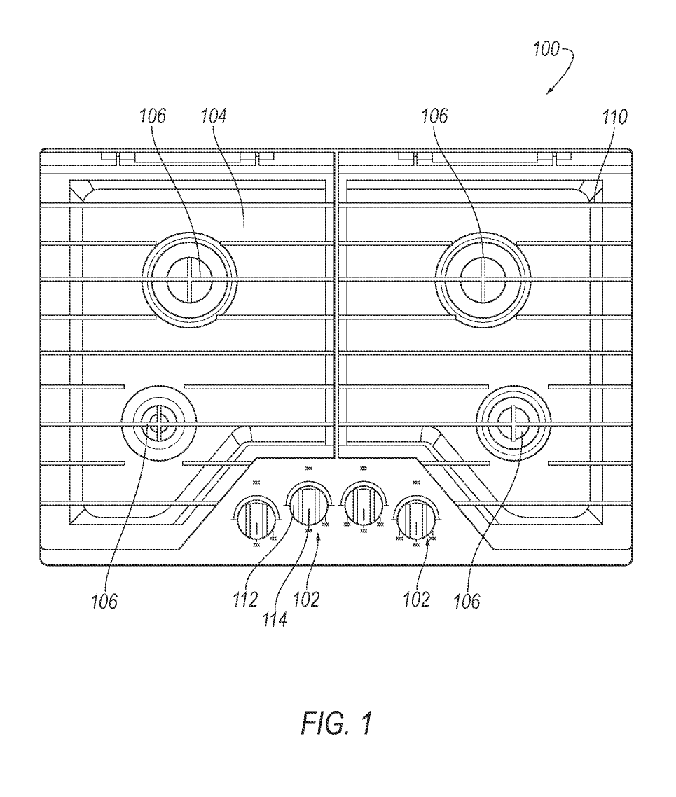

FIG. 1 illustrates an example cooktop 100, such as a gas range assembly. The cooktop 100 may include a cooking area 104 having a plurality of burners 106, each controlled by a knob 102. Each separately controlled burner 106 is dedicated to supplying heat to that area of the cooking area 104. The heat supplied to each separately controlled heating area is controlled such that a command to change the heat supplied to it may not change the amount of heat supplied to any other separately controlled cooking area 104. In the example of FIG. 1, the cooktop 100 has four separately controlled cooking areas 104, but more or fewer cooking areas 104 may be included.

One or more grates 110 may be arranged above the cooking area 104 in order to maintain cookware thereon a predefined distance above the burners 106. Each grate 110 may be made of metal, iron, or some other thermally conductive element. Each burner 106 may be operable to heat to desired cooking temperatures. In an example, each knob 102 is configured to control the flow of gas to a respective one of the burners 106. The knobs 102 may be labeled to allow a user to identify which knob 102 controls which of the burners 106. The burners 106 are configured to generate controlled flames that may be used to heat cookware arranged on the grate 110. The magnitude of the flame generated by the burners 106 is proportionate to the amount of gas flowing to the burners 106. A user may adjust the flow of gas to the burners 106 using the knobs 102. As the user rotates each of the knobs 102, a gas control valve (not shown) changes the amount of gas flowing to the corresponding burner 106.

While the knobs 102 in the example of FIG. 1 are illustrated as being arranged on top of the cooking area 104, the knobs may also be arranged on a front surface of a manifold of the cooktop 100. The knobs 102 may include markings therearound to indicate a certain level of heat being supplied by the burner 106 relative to the rotational position of the knob 102. For example, markings associated with a high, medium, low, simmer settings may be included. Each knob 102 has a face 112 with a grip 114 extending outwardly from the face 112. It should be appreciated that in other embodiments each knob 102 may be contemplated, such as the knob 102 being shaped as a cylinder or oval without a grip.

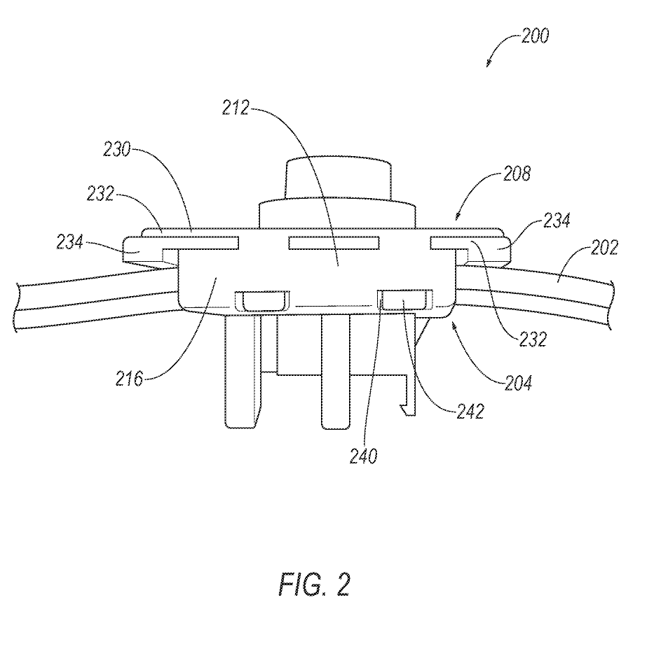

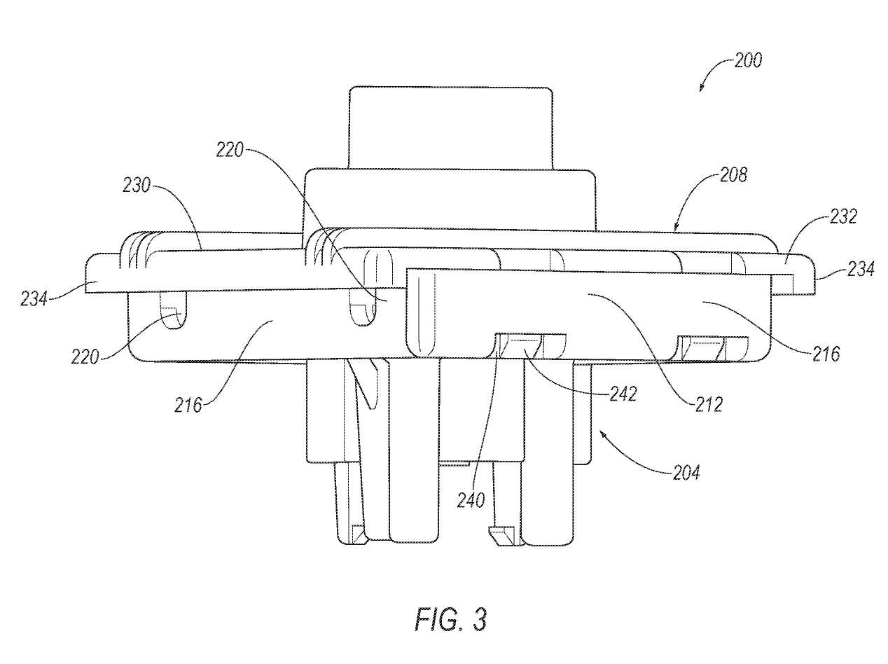

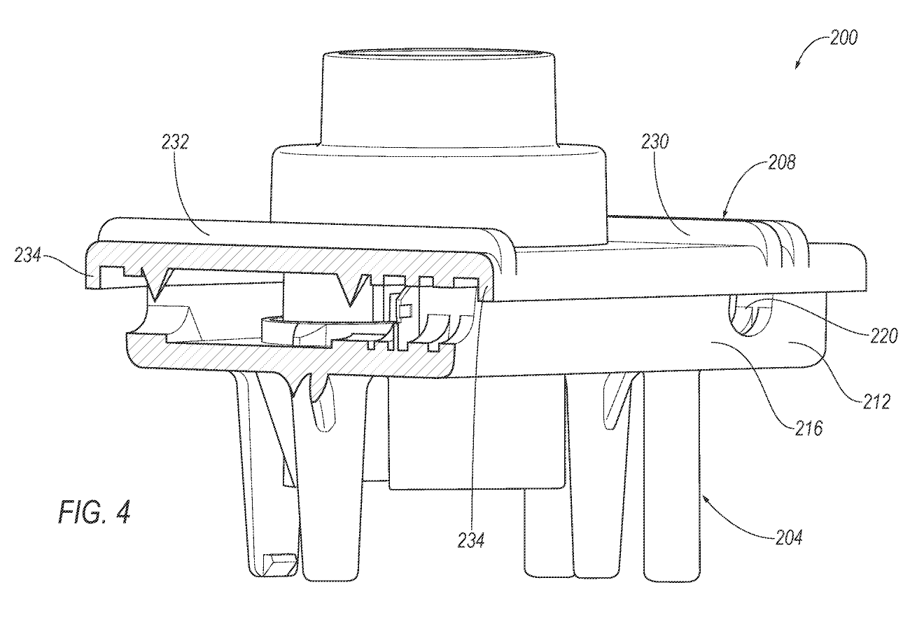

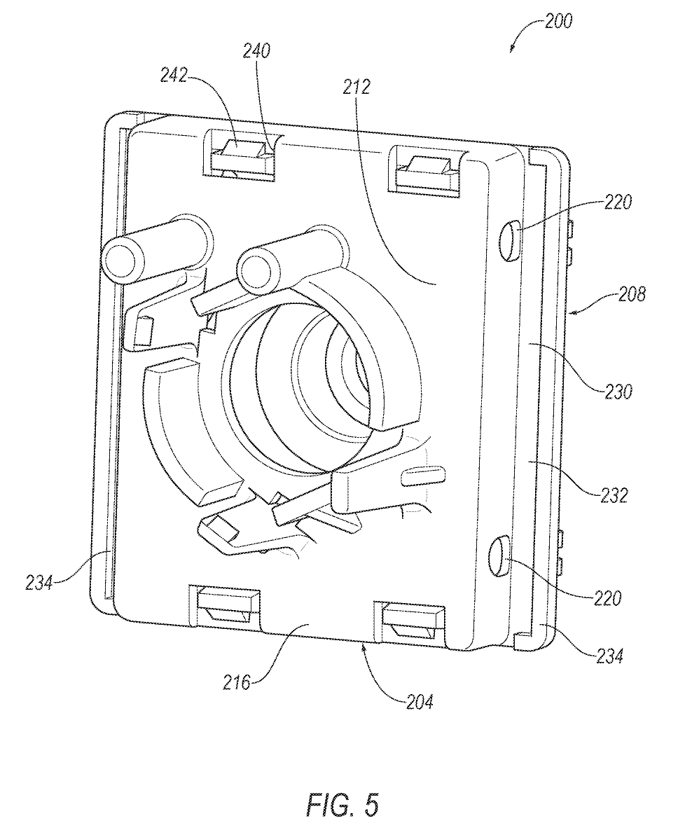

FIG. 2 illustrates side view of an example switch assembly 200 arranged at or near each of the knobs 102 and/or burners 106 of the example cooktop 100 in FIG. 1. The example switch assembly 200 has at least one wire 202 extending therefrom. FIG. 3 illustrates a perspective side view of the example switch assembly 200 of FIG. 2. FIG. 4 illustrates a cut-away perspective view of the example switch assembly 200 of FIG. 2. FIG. 5 illustrates a perspective bottom view of the switch assembly 200.

Referring to FIGS. 2-5, the switch assembly 200 may be mounted to a gas valve to ignite gas at the burners 106. The switch assembly 200 is configured to apply power to the spark module just prior to gas flow, to ignite the respective burner 106. As best seen in FIG. 2, the switch assembly 200 may include at least one wire 202 extending between a switch base 204 and a cover 208.

The base 204 may include a base body 212 creating a hollow interior. The base body 212 may be open at the top in an uninstalled state. In the example shown, the base body forms a quadratic shape having four sides 216. Other shapes may also be contemplated, and depiction and discussion of a quadratic shape is not intended to be limiting. Two opposite sides 216 may each define at least one wire hole 220 configured to receive the wire 202. As best shown in FIG. 3, a pair of wire holes 220 may be defined in the sides of the base body 212. The wire holes 220 may be open at the top of the base body 212 in order to receive the one or more wires 202 therethrough during assembly. The wire holes 220 may be aligned with the wire holes 220 on the opposite side 116 of the base body 212.

Each wire hole 220 may be configured to receive a seal. When the wire hole 220 receives the wire 202, the wire 202 may extend outwards from the base 204 through the wire hole 220.

The cover 208 may be configured to close and attach to the base 204, thus enclosing the hollow interior defined by the base body 212. The cover 208 may include a flat portion 230 configured to extend across the base 204. The flat portion 230 may have a length greater than that of the longest length of the base 204 such that the cover 208 extends over the opposite sides 216 of the base 204, creating an overhang 232 or ledge. The overhang 232, as best seen in FIG. 2, creates a cover over a portion of the wire 202, as well as the wire holes 220. The cover 208 limits the wire 202 extending from the base 204 from extending upward and away towards the cover 208. Instead, the cover 208 forces the wires downward towards the base 204. The cover 208, in this way, protects the wire 202 within the base 204 and wire hole 220 from being unduly exposed to liquid during tests, such as sponge testing.

Further, each overhang 232 may include a lip 234, block, or projection extending from the underside at the distal most end of each opposite ends 216 of the cover 208. The lip 234 may extend laterally across at least a portion of the end of the cover 208 to further define a guide to force the wire 202 downward towards the base 204. The lip 234 may form a seal with the wire when 202 when the wire 202 abuts the lip 234. That is, when the wire 202 is at an upward angle, fluid may flow down towards the switch. The lip 234 creates a seal or block to stop the fluid.

The lip 234 may extend generally perpendicularly from and along the edge of the flat portion 230 of the cover 208 to the wires 202. In one example, the lip 234 may form a 90 degree angle with the flat portion 230 to create an edge or ledge at the end of the flat portion 230. This extension formed by the lip 234 may allow for efficient manufacturing while providing the functionality of pushing the wires 202 downward without the inclusion of additional parts. The flat portion 230 creates a relatively non-robust profile for the cover 208, where traditionally larger housings or covers are necessary.

The cover 208 may attach to the base 204 once the wires are received within the base body 212 and wire holes 220. This may be achieved via an attachment mechanism configured to secure the two components together. In one example, the attachment mechanism may include a snap-fit or interference fit arrangement. The base 204 may define at least one slot 240. The slot 240 may be configured to receive a flexible projection 242 extending from the cover 208. The flexible projection 242 may include a lip to secure a snap-fit within the slot 240 once received. The snap-fit assembly may allow for easy assembly and disassembly of the cover 208 and base 204.

Other attachment mechanisms may also be contemplated, including both permanent and semi-permanent methods. In one example, the components may be attached via welding, adhesives, riveting, soldering, and in other examples, the components may be attached via the use of mechanical attachment components such as bolts, screws, etc., press fitting, magnets, clamps, etc.

The base 204 and cover 208 may be formed of a plastic such as polyethylene, polypropylene, polyvinyl chloride, acrylonitrile butadiene styrene, polystyrene, polyethylene terephthalate, polycarbonate, etc. The base 204 and cover 208 may be made of different plastics or materials from one another, or be the same material.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

What is claimed is:

1. A switch assembly for a cooktop, comprising:
a base portion having a base body forming a cavity and defining at least one wire hole at each of opposite ends of the base portion, the base portion configured to receive at least one wire therein, wherein the at least one wire extends out of a respective wire hole of the wire holes at the opposite ends of the base body; and
a cover attachable to the base portion and configured to close the cavity to maintain the at least one wire within the cavity,
wherein, the cover has a length longer than that of base portion such that the cover includes an overhang corresponding to each opposite end extending beyond the opposite ends of the base body to cover at least a portion of the at least one wire extending from the wire holes of the base body, the overhang further limiting the at least one wire from extending upward and away from the base portion to limit exposure to the wire holes and inhibiting exposure to liquid at the wire holes.

2. The assembly of claim 1, wherein each overhang forms a lip extending towards the base portion at each of two distal and opposite ends of the cover to further guide the at least one wire towards the base portion to limit exposure to the wire holes.

3. The assembly of claim 1, wherein each of the lips extend across the respective distal end of the cover.

4. The assembly of claim 1, wherein each of the at least one wire holes includes a pair of wire holes defined at each of the opposite ends of the base portion.

5. The assembly of claim 4, wherein the base portion defines an open top configured to receive the at least one wire in the cavity during assembly and the wire holes being open to the open top.

6. The assembly of claim 1, wherein the cover includes at least one attachment mechanism configured to engage and connect with the base portion during assembly.

7. The assembly of claim 6, wherein the attachment mechanism includes at least one projection configured to engage with a slot defined in the base portion.

8. A switch assembly for a cooktop, comprising:
a quadratic base portion having a base body forming a cavity and defining wire holes at each of opposite sides of the base portion, the base portion configured to receive at least one wire therein, wherein the at least one wire extends out a respective wire hole of the wire holes at the opposite sides of the base body;
a quadratic cover attachable to the base portion and configured to close the cavity to maintain the at least one wire within the cavity, and
wherein the cover has a length longer than that of base portion such that the cover includes an overhang at each opposite end extending beyond the opposite sides of the base body to cover at least a portion of the at least one wire extending from the wire holes of the base body, the overhang further limiting the at least one wire from extending upward and away from the base portion to limit exposure to the wire holes and inhibiting exposure to liquid at the wire holes.

9. The assembly of claim 8, wherein each overhang includes a lip extending towards the base portion at each of two distal and opposite sides of the cover to further guide the at least one wire towards the base portion to limit exposure to the wire holes.

10. The assembly of claim 8, wherein each of the lips extend across the respective distal end of the cover.

11. The assembly of claim 8, wherein each of the at least one wire holes includes a pair of wire holes defined at each of the opposite sides of the base portion.

12. The assembly of claim 11, wherein the base portion defines an open top configured to receive the at least one wire in the cavity during assembly and the wire holes being open to the open top.

13. The assembly of claim 8, wherein the cover includes at least one attachment mechanism configured to engage and connect with the base portion during assembly.

14. The assembly of claim 13, wherein the attachment mechanism includes at least one projection configured to engage with a slot defined by the base portion.

15. A cover attachable to a base assembly of a switch assembly for a cooktop, comprising:
a flat portion closing an open cavity of a base housing at least one wire that extends out each opposite end of the base, the cover having a length longer than the base and defining an overhand at each opposite end extending beyond the opposite end of the base to cover at least a portion of the wire extending from the opposite ends of the base,
a lip formed at each of two distal and opposite ends of the cover to limit the at least one wire from extending upward and away from the base portion to limit exposure to the wire holes and inhibiting exposure to liquid at the wire holes.

16. The cover of claim 15, wherein each lip extends towards the base at each of two distal and opposite ends of the cover to further guide the at least one wire towards the base portion to limit exposure to the wire holes and create a seal with the abutting wire to prevent liquid from reaching the base.

17. The cover of claim 15, wherein each of the lips extend across the respective distal end of the cover.

18. The assembly of claim 15, further comprising at least one attachment mechanism configured to engage and connect with the base during assembly.

19. The assembly of claim 18, wherein the attachment mechanism includes at least one projection configured to engage with a slot defined in the base portion.
